(19) United States
(12) Patent Application Publication
(10) Pub. No.: US 2008/0127270 A1
(43) Pub. Date: May 29, 2008

(54) Browsing video collections using hypervideo summaries derived from hierarchical clustering

(75) Inventors: Frank M. Shipman, College Station, TX (US); Andreas Girgensohn, Palo Alto, CA (US); Lynn D. Wilcox, Palo Alto, CA (US)

Correspondence Address: FLIESLER MEYER LLP, 650 CALIFORNIA STREET, 14TH FLOOR, SAN FRANCISCO, CA, 94108, US

(73) Assignee: FUJI XEROX CO., LTD., Minato-ku (JP)

(21) Appl. No.: 11/498,686

(22) Filed: Aug. 2, 2006

(51) Int. Cl. G06F 3/00

(52) U.S. Cl. 725/46

(57) ABSTRACT

The invention provides for quickly browsing through a large set of video clips to locate video clips of interest. In an embodiment of the present invention, hierarchical clustering of the video clips can be undertaken enabling the user to successively identify the subgroup of video clips of interest. This approach generates a video summary for the contents of each cluster by selecting representative video clips from individual videos and lower level clusters within the cluster. Links are added between the more general, higher-level clusters and the elements they contain. Thus, starting at the top of the set of videos being browsed or returned by the search engine and continuing at each subsequent cluster level, the user is presented with video summaries for the relevant parts of videos and those of next lower-level clusters. The user can then follow the navigational link to the desired video or lower-level cluster.

### CROSS REFERENCE TO RELATED APPLICATIONS

This application is related to the following applications:

(1) “METHOD AND SYSTEM FOR GENERATING MULTI-LEVEL HYPERVIDEO SUMMARIES” by Andreas Girgensohn, et al., U.S. patent application Ser. No. 10/612,428 filed Feb. 13, 2003 (Attorney Docket No. FXPL-01065US0 MCF) which is herein expressly incorporated by reference in its entirety; and

(2) “METHOD FOR AUTOMATICALLY PRODUCING OPTIMAL SUMMARIES OF LINEAR MEDIA” by Jonathan Foote, et al. which issued as U.S. Pat. No. 7,068,723 (Attorney Docket No. FXPL-01031US0 MCF) which is herein expressly incorporated by reference in its entirety.

### FIELD OF THE INVENTION

The invention is in the field of media analysis and presentation and is related to systems and methods for presenting search results, and particularly to a system and method for presenting video search results.

### BACKGROUND OF THE INVENTION

Searching for relevant portions of videos in a large digital video library can be difficult. The user can either browse through the entire collection or limit the scope of browsing by searching for videos or portions of videos with particular metadata and visual characteristics, or relationships to search terms. After searching the video library, users are left with a potentially long list of videos that match their query. Thus the task of finding relevant portions in those videos where those videos might contain unrelated content (e.g., a news video) can also be difficult. Often, the title and other meta-data associated with the video do not provide enough information to determine the relative merits of these videos, so the user needs to preview them in turn until they find what they need. This can be time-consuming when the number of potentially relevant videos is large. The tasks become even more substantial if only portions of videos are of interest to the user because not only the relevant videos have to be located but also the relevant portions inside them.

Clustering videos based on either low-level properties (e.g., color histograms) or semantic properties (e.g., genre) has been carried out where the clusters are hand-labeled or automatically detected (E. Bertino, J. Fan, E. Ferrari, M.-S. Hacid, A. K. Elmagarmid, X. Zhu. A hierarchical access control model for video database systems. ACM Transactions on Information Systems, 21(2), pp. 155-191, 2003; C.-W. Ngo, T.-C. Pong, and H.-J. Zhang. On clustering and retrieval of video shots. ACM Multimedia '01, pp. 51-60).

Data clustering algorithms can be hierarchical or partitional. Hierarchical algorithms find successive clusters using previously established clusters, whereas partitional algorithms determine all clusters at once. Hierarchical algorithms can be agglomerative (bottom-up) or divisive (top-down). Agglomerative algorithms begin with each element as a separate cluster and merge them in successively larger clusters. Divisive algorithms begin with the whole set and proceed to divide it into successively smaller clusters.

### SUMMARY OF THE INVENTION

In an embodiment of the present invention, a method of rapidly browsing through a video collection is described. In an embodiment of the present invention, the video collection can be either an entire library, a section of the library, or a list of videos generated in response to a query. The method is based on hierarchical clustering of videos by human-authored and/or automatically computed attributes of the video. Access to these clusters is provided through interactive hypervideo. In an embodiment of the present invention, a user can browse from more general groupings/clusters of videos to more specialized groupings/clusters of video. In this manner a user can progressively narrow their focus.

In an embodiment of the present invention, clusters are presented as a hypervideo enabling the user to successively identify the subgroup of video clips of interest and ultimately the desired videos. This approach generates a video summary for the contents of each cluster by selecting representative video clips from individual videos and lower level clusters within the cluster. Cluster links are added between the more general, higher-level clusters and the elements they contain. Thus, starting at the top of the set of videos being browsed or returned by the search engine and continuing at each subsequent cluster level, the user is presented with video summaries for the relevant parts of videos and those of next lower-level clusters. At any level of the cluster tree, the user views a video summary of the videos in a cluster. The summary is composed of representative clips from each of the sub-clusters. In an embodiment of the present invention, a user has three options while watching the summary. First, a user can follow a link for “more videos like this”. This link goes to the sub-cluster represented by the currently playing clip. Second, a user can choose a link for “this video” to see the entire video for the currently playing clip was extracted from. Finally, a user can do nothing and allow the video to continue with the next representative clip in the summary.

Clustering of videos can be performed to enable a user to only view a video summary of the cluster to determine whether or not videos in the cluster are likely to be of interest. Clustering is performed hierarchically, to enable the user to navigate down through the cluster tree until there are only a few videos in a cluster. A user can navigate to a specific video by selecting the link during the playing of a particular video summary.

This summary is not intended to be a complete description of, or limit the scope of, the invention. Alternative and additional features, aspects, and objects of the invention can be obtained from a review of the specification, the figures, and the claims.

### BRIEF DESCRIPTION OF DRAWINGS

This invention is described with respect to specific embodiments thereof. Additional aspects can be appreciated from the Figures in which:

FIG. 1 shows schematically the relationship between a video represented on the top right as a series of frames and a Hypervideo (top left), which is made up of portions of videos including the video (middle right), which is representative of a cluster (bottom left). The Hypervideo provides access to the results of clustering;

FIG. 2 a representation of the screen interface of a Hypervideo player with keyframe links for each of the portions of videos making up the Hypervideo; and

FIG. 3 a representation of the screen interface of a Hypervideo player for browsing search results.

### DETAILED DESCRIPTION OF THE INVENTION

In an embodiment of the present invention, a hypervideo can be created as follows. At any level of the cluster tree, a user can be shown a video segment that summarizes the contents of the cluster. This video can be created by concatenating representative clips from each of the directly linked sub-clusters. If the sub-cluster is a single video, either its representative clip can be used in the summary or only the relevant clips of that video can be considered. If the sub-cluster contains multiple videos, clips from representative videos for the cluster can be used. The representative videos for a cluster can be determined by the clustering algorithm that is either applied to whole videos or to clips inside those videos. The representative clip for a video can be determined by the algorithms described in U.S. Pat. No. 7,068,723, which identifies a clip that is most similar to the entire video. Other factors such as technical quality and an importance measure based on criteria such as the length of a video segment may also be used.

### Clustering Video

This aspect of the invention proposal discusses how video clips or whole videos are clustered so as to generate useful groupings. In various embodiments of the present invention, different clustering algorithms can be utilized. In an embodiment of the present invention, top down hierarchical k-means clustering can be used. In an alternative embodiment of the present invention, bottom up agglomerative clustering can be used to sort the videos into useful groupings. The distance measure for the clustering algorithms can be based on a combination of video attributes including the date and length of the video, its average shot length, average color composition, associated text from closed captioning or transcripts, human-attached metadata like author, producer, actors, characters, locations, genre, keywords, and notes. If the videos are the results of a query, the results can also be clustered based on relevance. Text-based clustering (based on either transcripts or metadata) will likely produce the best results but other attributes such as detected faces can produce useful results.

### K-Means Algorithm.

A k-means algorithm assigns each point to the cluster whose centroid is nearest. The center is the average of all the points in the cluster (i.e., its coordinates are the arithmetic mean for each dimension separately over all the points in the cluster). A k-means algorithm is top down. In an embodiment of the present invention, standard hierarchical k-means clustering can be used to generate a cluster tree of videos. In an embodiment of the present invention, it is assumed that each video clip or video can be represented by a feature vector in a Euclidean space, and that the distance between video clips or videos is simply the distance between feature vectors in space. For example, in an embodiment of the present invention, where the videos are grouped by genre, a feature vector might be composed from the average color histogram for the video, the length of the video, and the average shot length, and the distance might be a variance weighted Euclidean distance between feature vectors. Another example might be clustering video clips based on associated text. In this case the features can be a term vector and the distance can be the cosine distance.

If video clips are clustered based on associated text, a term vector represents t the frequency of each possible term in the associated text. Term frequencies might be modified by term weights that take into account the overall frequency of each term across the collection of videos. Because term vectors are very sparse, distance measures can be improved by translating each term vector into a lower-dimensional space using techniques such as latent semantic analysis. The distance between two term vectors can be measured by the cosine distance that is the dot product of the two vectors.

The k-means clustering algorithm begins with all videos in a single root cluster. In an embodiment of the present invention, the cluster can be split into N sub-clusters as follows:
1) Set the mean of each sub cluster to be a random offset of the mean of the root cluster.
2) Perform standard k-means clustering by assigning each video to the nearest sub-cluster based on the distance of the video to the sub-cluster mean.
3) Update the sub-cluster mean based on the inclusion of the new member (video).
   Once the algorithm has converged, a similar procedure is performed for each sub-cluster, until all sub clusters have less than N videos. In an embodiment of the present invention, N=5 can be used. In various embodiments of the present invention, other values of N are possible.

### Agglomerative Clustering Algorithm.

An agglomerative clustering algorithm builds the hierarchy from the individual elements by progressively merging clusters. An agglomerative clustering algorithm is bottom up. In an embodiment of the present invention, each video clip or video is placed in its own cluster. Next sequentially combine the two nearest videos into a single cluster. In various embodiments of the present invention, the distance between clusters can be defined as the minimum, maximum, or average distance between videos in the clusters. In an embodiment of the present invention, the maximum distance can be used because that leads to more tightly grouped clusters. The hierarchical clustering can be performed by combining the two clusters that produce the smallest combined cluster. Initially, each image represents its own cluster. The altitude of a node in the tree represents the diameter (maximum pair-wise distance of the members) of the combined cluster. Clusters are represented by the member closest to the centroid of the cluster. Note that the video segments in the tree are not in temporal order. The algorithm terminates when there is a single cluster. In an embodiment of the present invention, agglomerative clustering does not need a feature vector, only a distance measure. Such distance measures can be based on attached text (e.g. the cosine difference between the term vectors for video clusters) or based on visual and metadata attributes (e.g. the color histogram difference between the average histograms of video clips combined with the number of common actors).

Cluster trees based on agglomerative clustering are binary. In an embodiment of the present invention, to reduce the number of levels that need to be traversed, cuts through the tree can be taken to create N sub-trees for the node in question. Starting at the top level of the tree, a cut can be made that gives N sub-trees.

### Representative Video and Clips

In various embodiments of the present invention, one or more representative video clips or videos can be chosen to indicate the contents of the cluster in the hypervideo. In an embodiment of the present invention, a single representative video clip or video can be chosen, although the algorithms can be easily updated to select any number of representative videos by selecting representative videos for sub-clusters within the cluster in question. In an embodiment of the present invention, for the k-means algorithm the representative video for a cluster is defined as that video closest to the mean for the cluster. In an embodiment of the present invention, for the agglomerative clustering algorithm, the representative video for the cluster is the one that has the smallest sum of distances to the other videos in the cluster.

When working with entire videos, representative clips from a representative video can be determined using the techniques given in U.S. Pat. No. 7,068,723, which are based on the similarity of each clip to the rest of the video. If several representative video clips for a cluster are chosen, a subset of those clips can be chosen in the same way. Other factors, such as technical quality, or an importance measure based on search criteria such as the length of a video segment or the occurrence of search terms within and/or near the video clip can also be used.

### Example

For example, if a user searched for “jaguar” a number of videos or video clips may be found. The videos or video clips can be clustered into cats, cars, and consumer electronics products. The cluster on cars can be further subdivided into car dealers, maintenance, and toy cars. The cluster on consumer electronics products can be further subdivided into Mac OS 10.2 (Jaguar), an IBM consumer electronics product and Atari Jaguar, a Motorola consumer electronics product.

### Generating Hypervideo From Cluster Trees

To create the hypervideo that is used to browse the cluster tree, every non-terminal cluster (a non-terminal cluster has at least one sub cluster that is not a single video clip or video) has to have N sub clusters. When using the k-means clustering algorithm, N is specified as the number of clusters when recursively applying the clustering algorithm. For the agglomerative hierarchical clustering algorithm, the binary cluster tree is recursively cut through to find N sub clusters for each cluster. The resulting clusters are not balanced in size, however, each will contain at least one video clip or video.

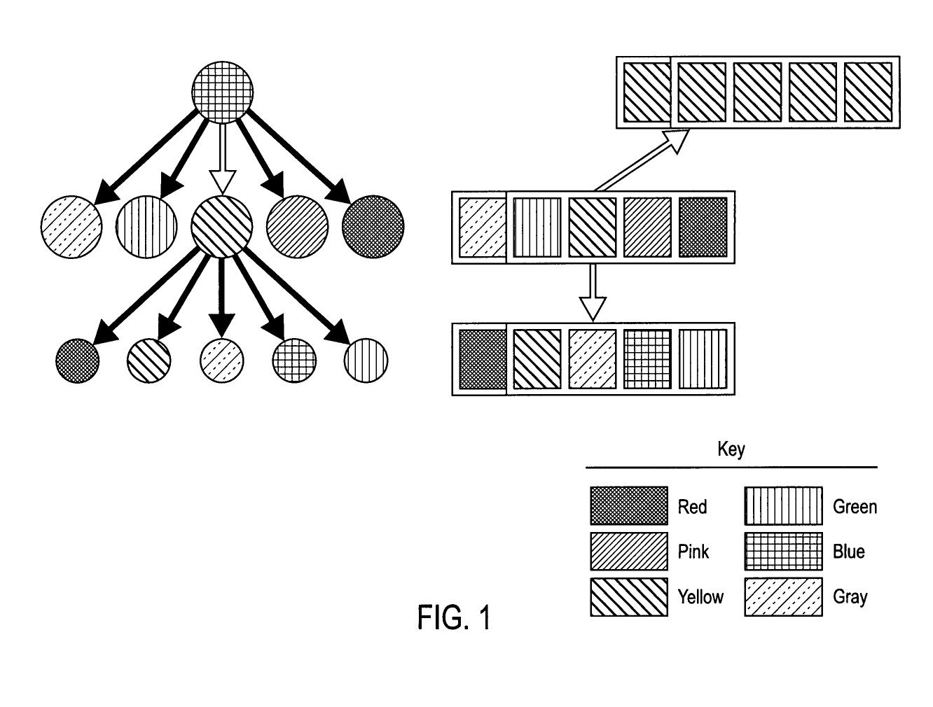

At each node of the tree a video sequence can be generated by concatenating the representative clips from each of the sub clusters (see FIG. 1). Hypervideo links are generated from each representative clip to the representative video or set of representative video clips of the corresponding sub-cluster and to the originating video clip. The algorithm stops when each sub cluster contains a single video clip or video.

Link labels can be used to aid navigation. When clustering is based on text or metadata attributes, the labels can be selected as the most frequent terms or attributes in the cluster. F. Chen, U. Gargi, L. Niles, H. Schutze, “Multi-Modal Browsing of Images in Web Documents”, SPIE '99; J. Adcock et al., “Method for Identifying Query-Relevant Keywords in Documents with Latent Semantic Analysis”, U.S. patent application Ser. No. 10/987,377. In cases where the clustering results will be used many times, such as in the case of an index into fixed library of video (e.g. a Yahoo!™-like categorization of videos), authors can refine the automatically-generated hypervideo in Hyper-Hitchcock (see U.S. Pat. No. 6,807,361) and add labels manually.

This algorithm generates hypervideos with navigational links from larger clusters to smaller clusters and to representatives of individual videos, from smaller clusters to representatives of individual videos, and from representatives of individual videos to the video itself (see FIG. 1). The representatives of individual videos can be left out of this hierarchically organized navigational structure when the individual videos are short or easily identifiable based on the first segments of their video content. The video player for viewing these clusters should include two buttons for link following: one to navigate to the sub cluster (e.g., “find mare like this”) and one to navigate to the video the clip is taken from (e.g., “show this video”).

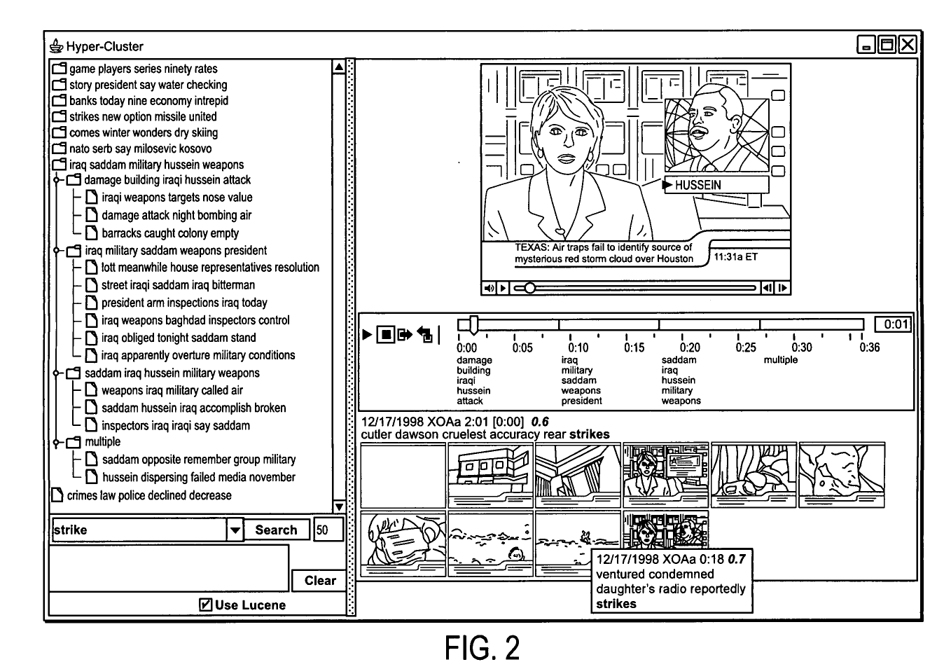

FIG. 2 shows a hypervideo player designed to work with hierarchically organized video collections that are visually distinctive. In addition to a link label, the player provides a keyframe for each link to enable the viewer to follow a link without watching the playback of the representative video or alternatively a user can follow a link to a cluster whose representative video has already finished playing. This collection of keyframes provides a separate index from the linked video because all keyframes are clickable without first having to navigate to that portion of the video.

### Using Hypervideo to Browse Search Results

These techniques can also be used to view clustered videos resulting from a query to a video collection. There are two methods for constructing the hypervideo based on the query. The first way assumes that the query is performed first, and that the relevant videos are then clustered and the hypervideo is created. Another method is to first create a cluster tree using the entire video collection. The query is then used for pruning of the cluster tree to eliminate all sub-trees not relevant to the query. After this, the hypervideo is created from the pruned tree. In this case, the representative videos for a cluster may be shorter since not all sub-clusters will be included.

If only relevant portions of videos are desired, the clustering can either be performed on video clips or whole videos can be clustered and the irrelevant portions of videos can be removed from the hypervideo summary. In the latter case, the hypervideo summary of a video can either be generated on the fly considering only the relevant portions of the video or cluster links pointing to irrelevant portions can be pruned or redirected.

FIG. 2 shows an example where the videos are clustered based on human-assigned metadata. When clusters are automatically generated (based on text, metadata, or visual properties), it is less obvious what videos will be found within a given cluster

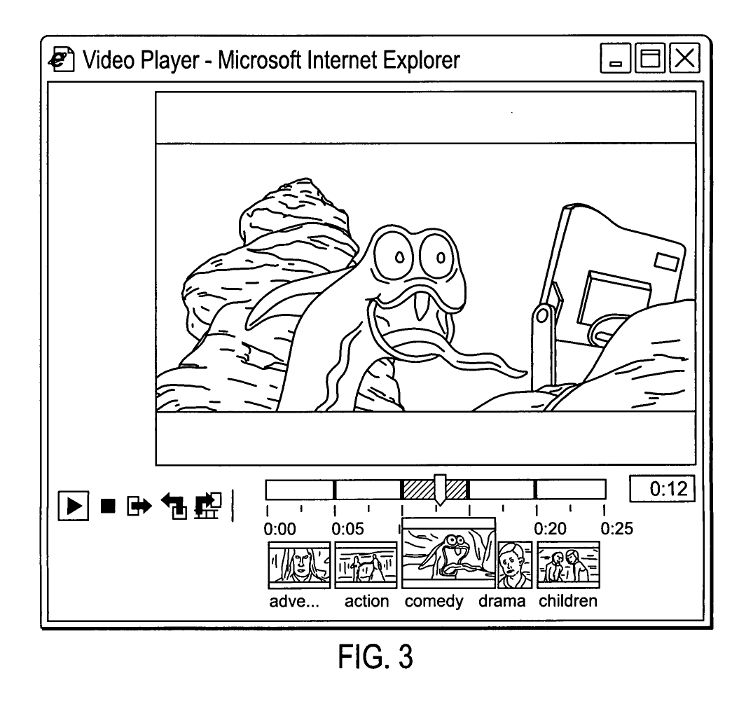

FIG. 3 shows a second hypervideo player for browsing search results in order to provide insight into the cluster tree for less visually distinctive video collections. In this case the video collection is news video and it is being clustered based on the transcript. Because the video is not visually distinctive (many shots of anchors or reporters), the keyframe is replaced with a set of terms identifying the cluster. To give a sense for the content in the clusters, terms that distinguish the cluster or video are selected as the label of the link. Also, the hypervideo structure is presented on the left as a tree displaying the terms for each cluster and video.

In the example in FIG. 3, the results for the query “strike” are grouped into clusters representing a basketball strike, pilot strikes and related economic events, and military strikes in Serbia, Iraq, and Israel. The cluster results are imperfect as they are based on automatically recognized speech and a heuristic segmentation of video streams into stories. Still, the resulting hypervideo lets the user explorer the search results by topic and the presentation of keywords associated with clusters and stories provides the user with a sense of where they are likely to find desired content.

Typical stock footage video libraries contain thousands of videos ranging in length from 3 minutes to two hours. The videos are indexed by keyword, location or date. However, even after querying the database by one or more of these indexes, there may still remain hundreds of videos to sort through. Creating a cluster tree and using hypervideo make it easier to search through the videos. The cluster tree can be generated using the text associated with the video, metadata indexes or by genre using content features.

Similarly, depending on the search options and algorithms for video databases such as TRECVID, a large number of potentially relevant videos or video segments can be returned. FIG. 3 shows how the search interface and hypervideo player can be used for evaluating the results of a TRECVID query. A video search method and system has been described for selecting the results of a search. “System for Presenting Search Results from a Collection of Videos”, A. Girgensohn et al., U.S. patent application Ser. No. 10/986,735.

In an embodiment of the present invention, the method can be used for searching a digital movie database. Typically, users browse through movies by category such as comedy or action. In an embodiment of the present invention a cluster tree, groups similar videos based on meta-data such as actor, location, or director or by the closed captioned text. This allows the user to browse the collection more quickly by using the subtree structure. FIG. 2 shows the search interface for such visually distinctive content.

In various embodiments of the present invention, hierarchical browsing and video summarization can be carried out using interactive hypervideo. In an embodiment of the present invention, algorithms for video clustering, finding representative videos and clips for summarization, and creating a hypervideo to interact with the collection are described. In an alternative embodiment of the present invention, the algorithms work with video segments.

In various embodiment of the present invention, a plurality of videos are segmented into a plurality of video segments, where each video segment is an uninterrupted subsequence of the video (i.e. where each frame of the video from the beginning of the video segment to the end of the video segment is included in the video segment in the same order as in the video). A distance measure can be used to represent each video segment, where the distance measure can be calculated based on an attribute of the video. A hierarchical cluster of the plurality of videos can thereby be generated based on the distance measure. In an embodiment of the present invention, a video subset can be selected at each cluster and used to create a hypervideo, where a navigational link combines the video subsets based on a hierarchic link between the clusters. The video subset can be one or more video segments chosen for each cluster. The attribute can be a date of the video, length of the video, length of the representative clip, average shot length, average color composition, technical quality, relevance of a query, closed captioning, text associated with closed captioning, transcripts of the associated text from closed captioning, occurrence of search terms within the representative clip, occurrence of search terms near the representative clip, author, producer, faces detected, object motion, actors, characters, locations, genre, keywords, notes or human made metadata.

In an alternative embodiment of the present invention, a representative video clip can be selected for each video segment to create a hypervideo, where a navigational link combines the representative video clips based on a hierarchical link between the clusters. The representative video clip can be one or more video segments chosen to be representative for each cluster.

In an embodiment of the present invention, a search of the plurality of videos can be used to select videos to be segmented and ultimately contribute to the hierarchical clustering and hypervideo. In an alternative embodiment of the present invention, the search can be used to prune the hierarchical cluster.

In an alternative embodiment of the present invention, the search criteria can be a relevance score, wherein the videos selected for inclusion and/or for pruning are retrieved based on the relevance score.

In an embodiment of the present invention, a distance measure between video segments can be the distance between feature vectors in space, where the feature vectors represent attributes in Euclidean space. In an alternative embodiment of the present invention, a distance measure between video segments is the one or more cosine distance between term vectors in space.

Example embodiments of the method and systems of the present invention have been described herein. As noted elsewhere, these example embodiments have been described for illustrative purposes only, and are not limiting. Other embodiments are possible and are covered by the invention. Such embodiments will be apparent to persons skilled in the relevant art(s) based on the teachings contained herein.

Thus, the breadth and scope of the present invention should not be limited by any of the above-described exemplary embodiments, but should be defined only in accordance with the following claims and their equivalents.

What is claimed is:

1. A method of clustering a plurality of videos comprising:
(a) selecting one or more video segment from the plurality of videos, where each video segment is an uninterrupted subsequence of the video;
(b) selecting one or more attribute;
(c) generating one or more distance measure for the one or more video segment based on the one or more attribute;
(d) generating one or more hierarchical cluster based on the one or more distance measure;
(e) selecting from each cluster one or more video subset of the one or more video segment, where a first video subset is selected from a first cluster and a second video subset is selected from a second cluster; and
(f) creating a hypervideo by combining the selected one or more video subset, where a navigational link combines the first video subset with a second video subset based on a hierarchic link between the first cluster and the second cluster.

2. The method of claim 1, wherein steps (e) and (f) further comprise:
selecting one or more representative video clip, where a representative video clip is a portion of a video segment, wherein each representative video clip is in the cluster, where a first representative video clip is selected from the first cluster and a second representative video clip is selected from the second cluster; and
creating a hypervideo by combining the selected one or more representative video clip, where a navigational link combines the first representative video clip with a second representative video clip based on a hierarchical link between the first cluster and the second cluster.

3. The method of claim 1, further comprising:
(g) selecting one or more search criteria;
(h) carrying out one or more search of the plurality of videos based on the one or more search criteria; and
(i) selecting video segments for inclusion in step (a) based on the search results.

4. The method of claim 3, wherein one or more of the search criteria is a relevance score, wherein the video segments selected for inclusion are retrieved in one or more search based on the relevance score.

5. The method of claim 1, further comprising:
(g) selecting one or more search criteria;
(h) carrying out one or more search of the plurality of videos based on the one or more search criteria; and
(i) pruning the hierarchical cluster in step (d) based on the search results.

6. The method of claim 5, wherein one or more of the search criteria is a relevance score, wherein the pruning of clusters corresponded to eliminating video segments not retrieved based on the relevance score.

7. The method of claim 1, where in step (a) one or more of the attribute is selected from the group consisting of date of the video, length of the video segment, length of the representative clip, average shot length, average color composition, technical quality, relevance of a query, closed captioning, text associated with closed captioning, transcripts of the associated text from closed captioning, occurrence of search terms within the video segment, occurrence of search terms near the video segment, author, producer, faces detected, object motion, actors, characters, locations, genre, keywords, notes and human made metadata.

8. The method of claim 1, where the hierarchical cluster tree is made up of clusters that each have at most ‘N’ subclusters.

9. The method of claim 1, where in step (c) the distance measure is generated by representing video segments by term vectors.

10. The method of claim 1, where in step (d) one or more of the hierarchical clusters are generated using a k-means clustering algorithm.

11. The method of claim 10, where in step (d) each video distance measure is generated by representing video segments by a feature vector in Euclidean space.

12. The method of claim 10, where in step (d) the number of subclusters ‘N’ is generated by recursively applying the clustering algorithm.

13. The method of claim 1, where in step (d) the hierarchical cluster tree is a binary cluster tree generated using an agglomerative clustering algorithm.

14. The method of claim 13, where in step (d) N is the number of subtrees of a cluster in the binary cluster tree, where N is determined by cutting through the tree.

15. The method of claim 1, where the one or more distance measure between video segments is the one or more distance between feature vectors in space.

16. The method of claim 1, where the one or more distance measure between video segments is the one or more cosine distance between term vectors in space.

17. The method of claim 13, where the cluster distance measure is selected from the group consisting of minimum distance, maximum distance and average distance.

18. A device for clustering a plurality of videos comprising:
(a) means for selecting a plurality of video segments from the plurality of videos, where each video segment is an uninterrupted subsequence of the video;
(b) means for selecting one or more attribute;
(c) means for generating one or more distance measure for the one or more video segment based on the one or more attribute;
(d) means for generating one or more hierarchical cluster based on the one or more distance measure;
(e) means for selecting from each cluster one or more video subset of the one or more video segment, where a first video subset is selected from a first cluster and a second video subset is selected from a second cluster; and
(f) means for creating a hypervideo by combining the selected one or more video subset, where a navigational link combines the first video subset with a second video subset based on a hierarchic link between the first cluster and the second cluster.

19. The system or apparatus for clustering a plurality of videos as per the device of claim 18, comprising:
a) one or more processors capable of specifying one or more sets of parameters; capable of transferring the one or more sets of parameters to a source code; capable of compiling the source code into a series of tasks for allowing a user to cluster a plurality of videos; and
b) a machine readable medium including operations stored thereon that when processed by one or more processors cause a system to perform the steps of specifying one or more sets of parameters; transferring one or more sets of parameters to a source code; compiling the source code into a series of tasks for allowing a user to cluster a plurality of videos.

20. A machine-readable medium having instructions stored thereon to cause a system to:
(a) select at least a portion of the plurality of videos into one or more video segment, where the video segment is an uninterrupted subsequence of the video;
(b) select one or more attribute;
(c) generate one or more distance measure for the one or more video segment based on the one or more attribute;
(d) generate one or more hierarchical cluster based on the one or more distance measure;
(e) select from each cluster one or more video subset of the one or more video segment, where a first video subset is selected from a first cluster and a second video subset is selected from a second cluster; and
(f) create a hypervideo by combining the selected one or more video subset, where a navigational link combines the first video subset with a second video subset based on a hierarchic link between the first cluster and the second cluster.
